(19) United States
(12) Patent Application Publication
(10) Pub. No.: US 2007/0153100 A1
(43) Pub. Date: Jul. 5, 2007

(54) IMAGE DISPLAY APPARATUS, IMAGE DISPLAY METHOD, CONTROL PROGRAM, AND IMAGING APPARATUS

(75) Inventor: Hiroya Miura, Shinagawa-ku (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/609,700

(22) Filed: Dec. 12, 2006

(30) Foreign Application Priority Data
Jan. 5, 2006 (JP) 2006-000669

(51) Int. Cl. H04N 5/262

(52) U.S. Cl. 348/239

(57) ABSTRACT

An image display apparatus holds plural color conversion information patterns for performing a color conversion of pixels of drawing data. The image display apparatus is capable of selectively changing color conversion information for performing a color conversion of pixels of the drawing data within the same display screen. The image display apparatus combines a main picture with the drawing data converted based on the color conversion information.

### BACKGROUND OF THE INVENTION

1. Field of the Invention

The present invention relates to an image display apparatus having an on-screen display (OSD) overlay/mix function.

2. Description of the Related Art

The image display apparatus, including televisions, digital cameras and digital video cameras, has a display unit that can display operation menus, icons, button names, characters, and graphic information. In general, a composite display can be realized by overwriting (overlaying) or mixing on-screen display (OSD) data on a main picture (video).

The on-screen display can be applied to a system capable of processing digital video signals, such as a digital video camcoder (hereinafter, referred to as “DVC”). The DVC can process a video signal (DV format) having standard definition (SD) resolution corresponding to the analog standard NTSC.

For example, the video signal processed by the DVC is a 60-interlace (i.e., 60i) video signal having horizontal resolution equal to 720 pixels and vertical line number equal to 480 lines/frame in an effective video range excluding a blanking range. If the type is 50i, the video signal has horizontal resolution equal to 720 pixels and vertical line number equal to 576 lines/frame in an effective video range excluding a blanking range.

It is now assumed that the on-screen display is overlaid/mixed to the pixel positions of the 60i video signal of 720×480 pixels/frame (=720×240 pixels/field). In this case, controlling ON/OFF of the on-screen display can be simply realized by using 1-bit information for instructing execution/non-execution of the on-screen display for each pixel.

However, 1-bit information is useless if composite processing by the on-screen display is required. For example, the composite processing realized by the on-screen display includes a color display, an overwrite display, a superimposed display, and a semi-transparent display required, for example, for displaying a main picture (video) as a background of an OSD image.

More specifically, it is necessary to allocate a sufficient number of bits to each of a luminance signal Y, a blue chrominance signal Cb/ a red chrominance signal Cr, and an attribute (e.g., display ON/OFF and overlay/mix method) signal. For example, the luminance Y signal requires 5 bits, the chrominance Cb/ Cr signals respectively require 4 bits, and the attribute signal requires 3 bits. As a result, the information required for each pixel is 16 (=5+4+4+3) bit/pixel.

However, as shown in FIG. 2, general 16-bit OSD information includes a plurality of tables independently providing color conversion information which may be generally referred to as a color look-up table (CLUT) or a palette.

FIG. 2 shows a total of 16 table numbers (i.e., OSD data code) respectively designating corresponding tables (i.e., 16-bit color look-up tables 0 through 15). Managing the table numbers in relation to display pixels is effective to suppress the entire information amount.

According to the example shown in FIG. 2, the table number (i.e., OSD data code) allocated for each pixel of the on-screen display is 4-bit data. An arbitrary CLUT can be selected by designating a corresponding table number from a total of 16 color cook-up tables. The on-screen display can be realized by arbitrarily combining 16 colors according to color information and attribute designated by each CLUT. Furthermore, the OSD colors to be displayed (or already displayed) and the display method can be easily changed by rewriting the contents of CLUT.

FIG. 3 illustrates an exemplary arrangement of a conventional OSD drawing system. A synchronous dynamic random access memory (SDRAM) 301 can hold 16-bit OSD data. The SDRAM 301 can be a common memory that stores, for example, various display data. An arbiter 302 can perform a memory control of the SDRAM 301.

In the conventional example, the arbiter 302 sends a read command to the SDRAM 301 in response to an OSD data acquisition request generated from an OSD control section 304. The arbiter 302 can transfer each 16-bit OSD data to a first in first out (FIFO) buffer 303 according to 64-burst units.

The FIFO buffer 303 can receive 16-bit burst data produced from the SDRAM 301 in accordance with the read command supplied from the arbiter 302. Furthermore, the FIFO buffer 303 can output separated 8-bit data in response to a data reading address and an enable signal supplied from the OSD control section 304.

The OSD control section 304 can send a data read request via the arbiter 302 to the SDRAM 301. Then, the OSD control section 304 can output an address and an enable signal in synchronism with display timing to obtain OSD data stored in the FIFO buffer 303 which was read out of the SDRAM 301.

An OSD data selector 305 can separate a multiplexed OSD signal from 8-bit data into 4-bit data so as to correspond to the phase of the display pixel. A selection signal (refer to “selector” shown in FIG. 3) is a signal inverting in synchronism with an OSD clock. The OSD data selector 305 includes a flip-flop (FF) circuit that can convert 8-bit multiplexed OSD data into 4-bit OSD data.

A color look-up table (CLUT) 306 is a color conversion table including 16 types of 16-bit overlay control (attribute) data (refer to FIG. 2).

An OSD mix processing section 307 can overlay and mix, on a main picture (video), OSD data produced from the CLUT 306 based on attribute information to output a composite video signal.

If the total number of color look-up tables is relatively small, the hardware arrangement can be formed by registers. Using firmware, arbitrary data (e.g., luminance, chrominance, and display attribute information) can be written into each CLUT register. The display OSD data can be stored in a work memory, while the table number of CLUT can be arranged by bitmap.

In synchronism with the display of a main picture (video), a CLUT number representing OSD data can be read out of the work memory. The OSD overlay display processing can be performed for each display pixel based on luminance/chrominance/display attribute information described in a corresponding CLUT.

According to the above-described arrangement, when the number of simultaneously displayed colors is small, the OSD information for each display pixel can be suppressed to a small amount of data. The display control can be efficiently performed (refer to Japanese Patent Application Laid-open No. 2000-305549).

However, if the number of simultaneously displayed colors is increased, more table numbers designating color look-up tables are required. Therefore, bit numbers designating the table numbers are also increased.

If the bit number allocated to each table number is increased from 4 bits to 5 bits, 6 bits, 7 bits, and 8 bits, the number of color look-up tables (i.e., the number of simultaneously displayed colors) can be theoretically increased from 16 colors to 32, 64, 128, and 256 colors.

In this manner, the data amount of (bitmap) OSD data stored in the work memory increases according to the number of color look-up tables and the data amount of OSD data. Furthermore, an increased band is required to access the memory and read the OSD data.

In general, the memory access requires a data width equal to the power of 2, if the bus width of a memory is taken into consideration. In a built-in system, the data width used for the memory access may be 8 bits/16 bits/32 bits depending on a memory selected.

For example, the access efficiency was satisfactory in a conventional system because the memory access width was an integer multiple of 4 bits.

However, if the OSD data of each pixel is increased to 5 bits from 4 bits, the memory access width cannot be an integer multiple of 5 bits and thus 8-bit data access is required for only one bit (=5 bits−4 bits) increase. In other words, 3 bits (=8 bits−5 bits) are useless.

As a technical solution, the data volume may be reduced while the address boundary and the data boundary may be arranged so as not to agree with each other. However, software management and hardware arrangement may be complicated and may not be practically used.

Furthermore, in the digital cameras and the digital video cameras (or other video devices), the work memory is commonly used for various image processing and cannot be exclusively used for the OSD function. Accordingly, the number of simultaneously displayed colors cannot be easily increased.

More specifically, the OSD function requires real time processing for the display. The memory access band is required to change in accordance with increase of information amount. As a result, not only in the memory access but also in other system control, the access latency (i.e., waiting time or delay time required in obtaining actual data in response to an access request to a memory) may deteriorate.

### SUMMARY OF THE INVENTION

Exemplary embodiments of the present invention are directed to an image display apparatus including a display section improved in visibility and design without increasing information amount of displayed OSD data.

According to an aspect of the present invention, an image display apparatus is configured to combine drawing data with image data and display a composite image. The image display apparatus includes: an image input unit configured to input image data; a drawing data input unit configured to input drawing data; a color conversion information holding unit configured to hold color conversion information for performing a color conversion of pixels of the drawing data; a composite processing unit configured to combine the image data inputted by the image input unit with drawing data converted based on the color conversion information; and a change unit configured to change the color conversion information allocated to the drawing data within a same display screen.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an OSD drawing system in accordance with a first exemplary embodiment.

FIG. 2 shows a color look-up table (CLUT) used in a conventional system or in the first exemplary embodiment.

FIG. 3 is a block diagram illustrating a conventional OSD drawing system.

FIG. 4 is a block diagram illustrating a digital video camera in accordance with the first exemplary embodiment.

FIG. 5 illustrates exemplary color conversion information patterns including dissected regions to which plural color look-up tables are allocated according to the first exemplary embodiment.

FIG. 6 illustrates exemplary color conversion information patterns including dissected regions to which plural color look-up tables are allocated according to a second exemplary embodiment.

FIG. 7 illustrates exemplary color conversion information patterns including dissected regions to which plural color look-up tables are allocated according to a third exemplary embodiment.

FIG. 8 illustrates exemplary color conversion information patterns including dissected regions to which plural color look-up tables are allocated by designating a coordinate function f(x) according to a fourth exemplary embodiment.

### DETAILED DESCRIPTION OF THE EMBODIMENTS

The following description of exemplary embodiments is merely illustrative in nature and is in no way intended to limit the invention, its application, or uses.

Processes, techniques, apparatus, and systems as known by one of ordinary skill in the art may not be discussed in detail but are intended to be part of the enabling description where appropriate.

For example, certain circuitry for image processing, data processing, and other uses may not be discussed in detail. However these systems and the methods to fabricate these system as known by one of ordinary skill in the relevant art is intended to be part of the enabling disclosure herein where appropriate.

It is noted that throughout the specification, similar reference numerals and letters refer to similar items in the following figures, and thus once an item is defined in one figure, it may not be discussed for following figures.

Exemplary embodiments will be described in detail below with reference to the drawings.

### First Exemplary Embodiment

An image display apparatus according to a first exemplary embodiment will be described with reference to attached drawings.

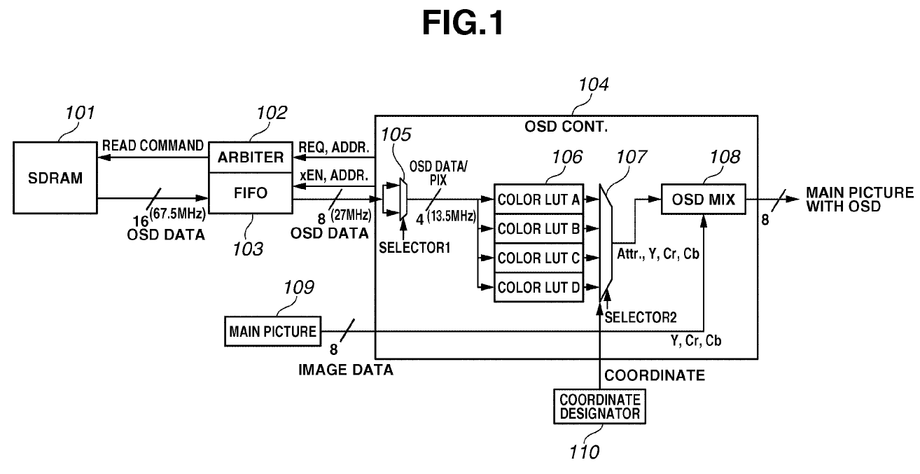

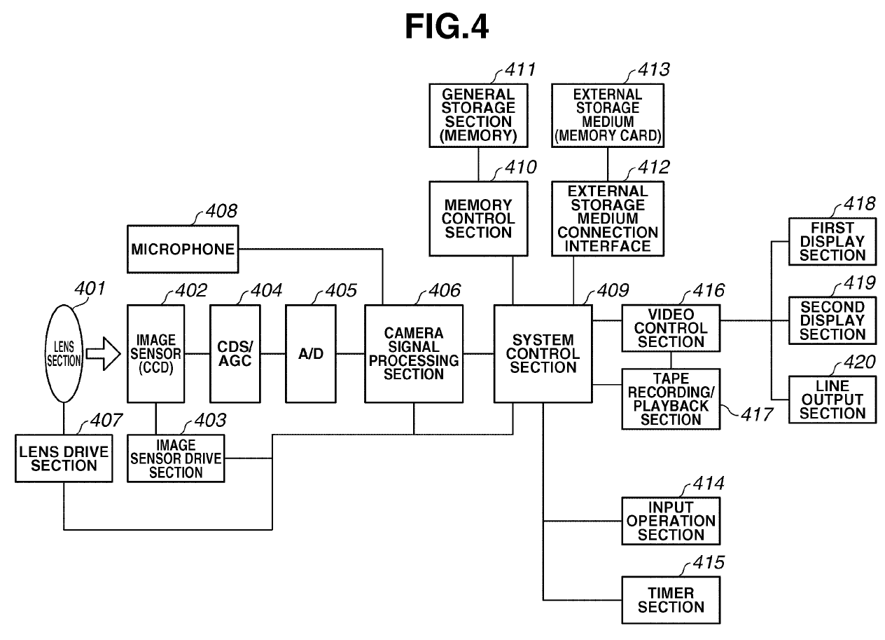

FIG. 4 is a schematic block diagram of a digital video camera functioning as an image display apparatus having an OSD overlay and image display function. FIG. 1 is a block diagram illustrating an OSD drawing system.

In the video camera, a lens section 401 (i.e., a lens group and a lens mechanism) has a zoom function and a focus adjustment function for capturing an image of a shooting subject (not shown). An image sensor 402 is a charge-coupled device (CCD) capable of capturing an image entered from an optical system including the lens section 401. An image sensor drive section 403 can drive the image sensor 402 at the timing instructed from a camera signal processing section 406.

A correlated double sampling (CDS)—auto gain controller (AGC) section 404 can sample an analog signal entered from the image sensor 402 and perform a gain control of the signal level based on a control signal supplied from a system control section 409. An analog to digital (A/D) converter 405 can convert the analog signal entered from the CDS/AGC section 404 into a digital signal.

The camera signal processing section 406 can cooperate with the system control section 409 to control various processing, e.g., timing generation, auto exposure (AE) control, gamma adjustment, auto focus (AF) control, for the camera imaging system. In addition to the AF function, the camera signal processing section 406 can calculate a distance of the shooting subject. The screen can include a total of nine AF areas dissected by screen lattices. The AF control can be applied to all AF areas or only the central AF area.

A lens drive section 407 can drive the lens section 401 to adjust a zoom magnification and a focus. In an auto focus mode, the camera signal processing section 406 detects focus adjustment information. The system control section 409 generates a control signal based on the detected information to drive the lens drive section 407. And, the lens drive section 407 controls the lens section 401 to perform the focus adjustment. In a manual focus mode, a user generally adjusts a focus ring (i.e., part of an input operation section 414) provided around the lens.

If the camera is equipped with an electronic mechanism, the system control section 409 can detect a rotational direction and a rotational amount of the focus ring and the lens drive section 407 can drive the lens section 401 based on the detection result so as to perform the focus adjustment. If the camera is equipped with a mechanical mechanism, a user can manually turn the focus ring which is linked to the lens section 401 so that the lens section 401 can be mechanically driven to perform the focus adjustment.

A microphone 408 can collect and record surrounding sounds in synchronism with a video entered from the imaging system. The system control section 409 can execute various control procedures relating to controls of the digital video camera based on programs stored in a later-described general storage section (e.g., memory) 411. The system control section 409 includes an OSD overlay block shown in later-described FIG. 1. A memory control section 410 can control access to the general storage section 411.

The general storage section (e.g., memory) 411 is a buffer memory used in the video signal processing, and can be a ROM or a RAM capable of storing programs and data required in various controls and functioning as a work region for the system control section 409 that executes the aforementioned various controls. The general storage section (e.g., memory) 411 can store on-screen display data (OSD data) to be displayed on the display section.

An external storage medium connection interface 412 provides a slot for an external storage medium (e.g., memory card) 413. In general, JPEG files obtained in the still image shooting operation can be stored in a memory card. An input operation section 414 includes a shooting start/stop button, a selection button, a determination button, a still image shutter button, and a manual focus ring.

A timer section 415, including a real time clock (RTC) and a backup battery, can count elapsed time and send date/time information to the system control section 409, if requested. A video control section 416, including a horizontal filter function section (refer to FIG. 1), can control output signals supplied to a first display section 418, a second display section 419, and a line output section 420. Furthermore, the video control section 416 can also control a tape recording/playback section 417.

The tape recording/playback section 417 can receive, from the video control section 416, video signals encoded in a predetermined tape recording format, e.g., a DV format according to an SD mode or an HDV format according to a HD mode. The tape recording/playback section 417 can record the received video signals on a tape and can play the video signals recorded on the tape.

The first display section 418 is an electrical view finder (EVF) that can display a video entered from the imaging system when the tape recording/playback section 417 records the video and can display a video recorded on a tape when the tape recording/playback section 417 performs a playback operation. Furthermore, the first display section 418 can display information relating to user's input operations entered from the operation section 414 and information relating to arbitrary images stored in the external storage medium.

The second display section 419 is a liquid crystal display panel that can display a video entered from the imaging system when the tape recording/playback section 417 records the video and also can play a video recorded on a tape when the tape recording/playback section 417 performs a playback operation. Moreover, the second display section 419 can display information relating to user's input operations entered from the operation section 414 and information relating to arbitrary images stored in the external storage medium.

The line output section 420 can function as an interface of analog component video output, S terminal output, and composite video output. The line output section 420 can be connected to an external television (TV) monitor to display a video output of the digital video camera on a television (TV) screen.

On the first display section 418 or the second display section 419, or on a TV screen connected to the line output 420, OSD data can be overlaid or combined (mixed) with a shooting video or a playback video to realize a composite display according to a method of the present exemplary embodiment.

Next, an OSD method applicable to the digital video camera shown in FIG. 4 will be described with reference to FIG. 1, in which a video with OSD data can be supplied to an EVF, a liquid crystal display panel, or a television monitor (i.e., line output destination).

A synchronous dynamic random access memory (SDRAM) 101 can function as a color conversion information holding section. The DRAM 101 can hold 16-bit OSD data. The SDRAM 101 can be a common memory that stores, for example, various display data.

An arbiter 102 can perform a memory control of the SDRAM 101. In the present exemplary embodiment, the arbiter 102 sends a read command to the SDRAM 101 in response to an OSD data acquisition request generated from an OSD control section 104. The arbiter 302 can transfer each 16-bit OSD data to a first in first out (FIFO) buffer 103 according to 64-burst units.

The FIFO buffer 103 can receive 16-bit burst data produced from the SDRAM 101 in accordance with the read command supplied from the arbiter 102. Furthermore, the FIFO buffer 103 can output separated 8-bit data in response to a data reading address and an enable signal supplied from the OSD control section 104. The display control section 104 can receive the data output from the FIFO buffer 103, as drawing data.

The OSD control section 104 can send a data read request via the arbiter 102 to the SDRAM 101. Then, the OSD control section 104 can output an address and an enable signal in synchronism with the display timing to obtain OSD data stored in the FIFO buffer 103 which was read out of the SDRAM 101.

An OSD data selector 105 can separate a multiplexed OSD signal from 8-bit data into 4-bit data so as to correspond to the phase of the display pixel. A selection signal “selector1” shown in FIG. 1 is a signal inverting in synchronism with an OSD clock. The OSD data selector 105 includes a flip-flop (FF) circuit that can convert 8-bit multiplexed OSD data into 4 bit OSD data.

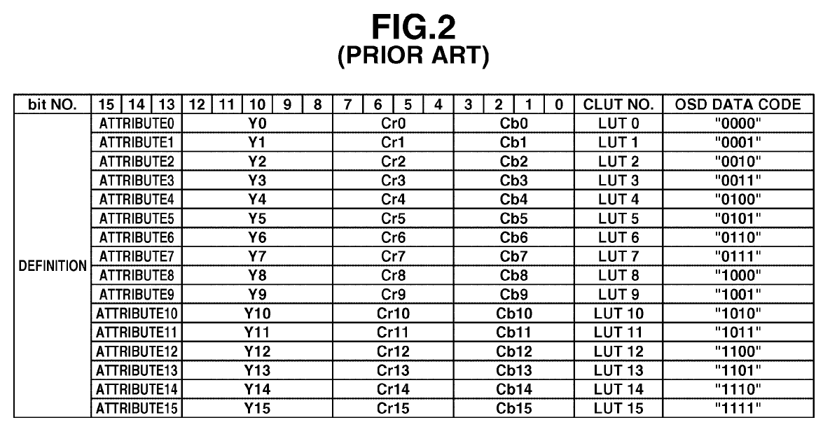

A color look-up table (CLUT) group 106 includes a total of four look-up tables (i.e., CLUT “A” to CLUT “D”) providing color conversion information. Each CLUT includes, as color conversion information, a color conversion table including 16 types of 16-bit overlay control (attribute) data as shown in FIG. 2.

A CLUT output selector 107 can select one of the color look-up tables (i.e., CLUT “A” to CLUT “D”) based on a later-described selection signal (refer to “selector2” shown in FIG. 1). In other words, the CLUT output selector 107 can determine which CLUT information of the groups is sent, as OSD drawing data, to an OSD mix processing section 108. The OSD drawing data can be allocated to plural regions on the display screen dissected according to a later-described coordinate designation.

The OSD mix processing section 108, functioning as a composite processing section, can perform overlay processing or mix processing to combine a main picture (video) with the OSD drawing data selected by the CLUT output selector 107 based on attribute information involved in the color conversion information. The OSD mix processing section 108 can output a composite video including the OSD drawing data to a monitor.

An image input section 109 can input image data produced from the imaging system and video data read out of a recording medium into the OSD control section 104.

A coordinate designation section 110 can arbitrarily designate a point (coordinate values) on the display screen. When the coordinate designation section 110 inputs arbitrary coordinate values into the CLUT output selector 107, the display screen can be dissected into a plurality of regions defined by horizontal and vertical lines. The method for designating a point (coordinate values) on the display screen will be described later.

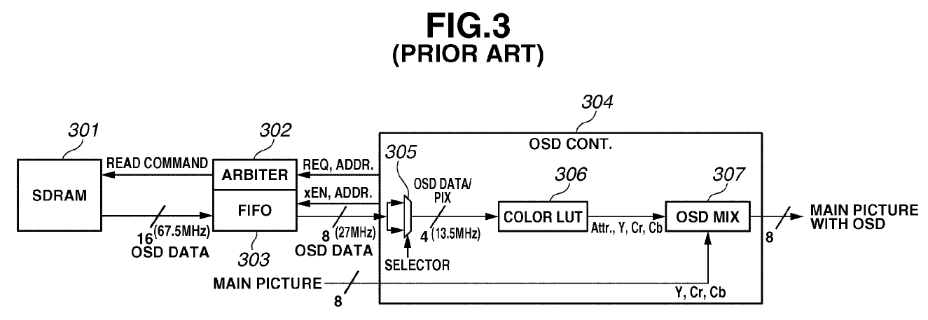

The OSD drawing system shown in FIG. 1 is different from the conventional example shown in FIG. 3 in that the CLUT group (i.e., a group of color look-up tables “A” to “D”) 106 is provided and the output selector 107 can selectively output one of a plurality of color look-up tables “A” to “D.” Furthermore, the selection signal “selector2” supplied to the output selector 107 can be controlled depending on each OSD region of the display screen.

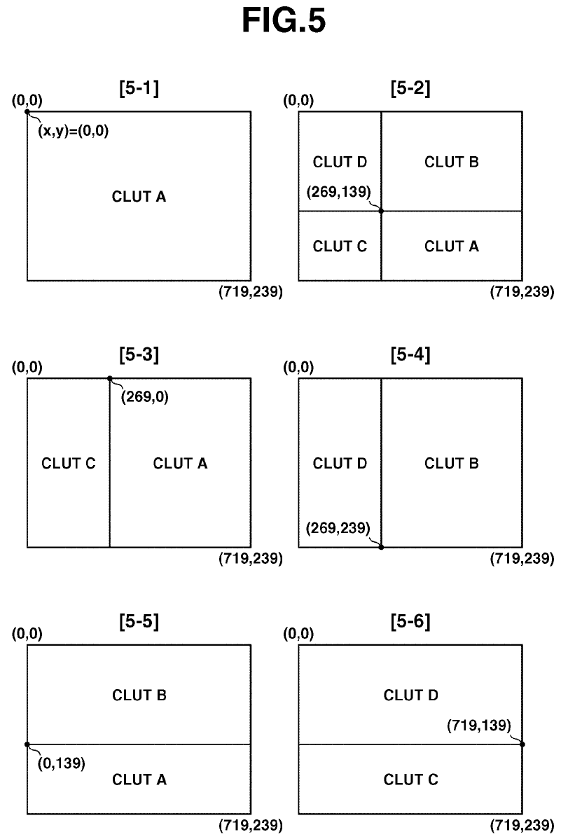

FIG. 5 illustrates plural examples with respect to allocation of color look-up tables. In each example shown in FIG. 5, the entire video range (i.e., effective video range) corresponds to a field defined by 0≦x≦719 and 0≦y≦239 in which “x” represents the horizontal direction and “y” represents the vertical direction.

The coordinate designation section 110 can designate an arbitrary coordinate point within the effective range. The vertical and horizontal lines passing through the coordinate point can define dissected regions to which color look-up tables can be allocated respectively.

An example 5-1 is obtainable when the designated coordinate point is equal to (x, y)=(0, 0). According to the example 5-1, only one CLUT (e.g., CLUT “A”) is allocated to the entire video range, the same as a conventional one.

An example 5-2 is obtainable when the designated coordinate point is equal to (x, y)=(269, 139). The vertical and horizontal lines passing through the coordinate point (269, 139) can provide a total of four dissected regions to which color look-up tables “A” to “D” are respectively allocated.

More specifically, to realize video display and OSD composite (overlay/mix) processing in the horizontal direction, the coordinate designation section 110 can control a selection signal (“selector2” shown in FIG. 1) supplied to the CLUT output selector 107 so as to produce a color conversion information pattern corresponding to the example 5-2, according to which the CLUT “D” is allocated to a region defined by 0≦x≦269 and 0≦y≦139; the CLUT “B” is allocated to a region defined by 270≦x≦719 and 0≦y≦139; the CLUT “C” is allocated to a region defined by 0≦x≦269 and 140≦y≦239; and the CLUT “A” is allocated to a region defined by 270≦x≦719 and 140≦y≦239.

An example 5-3 is obtainable when the designated coordinate point is equal to (x, y)=(269, 0). The vertical line passing through the coordinate point (269, 0) can provide two (right and left) dissected regions to which color look-up tables “A” and “C” are respectively allocated.

More specifically, the coordinate designation section 110 can control the election signal (“selector2” shown in FIG. 1) supplied to the CLUT output selector 107 so as to produce a color conversion information pattern corresponding to the example 5-3, according to which the CLUT “C” is allocated to a region defined by 0≦x≦269 and the CLUT “A” is allocated to a region defined by 270≦x≦719 with the boundary equal to x=269.

An example 5-4 is obtainable when the designated coordinate point is equal to (x, y)=(269, 239). The vertical line passing through the coordinate point (269, 239) can provide two (right and left) dissected regions to which color look-up tables “B” and “D” are respectively allocated.

More specifically, the coordinate designation section 110 can control the selection signal (“selector2” shown in FIG. 1) supplied to the CLUT output selector 107 so as to produce a color conversion information pattern corresponding to the example 5-4, according to which the CLUT “D” is allocated to a region defined by 0≦x≦269 and the CLUT “B” is allocated to a region defined by 270≦x≦719 with the boundary equal to x=269.

An example 5-5 is obtainable when the designated coordinate point is equal to (x, y)=(0, 139). The horizontal line passing through the coordinate point (0, 139) can provide two (upper and lower) dissected regions to which color look-up tables “A” and “B” are respectively allocated.

More specifically, the coordinate designation section 110 can control the selection signal (“selector2” shown in FIG. 1) supplied to the CLUT output selector 107 so as to produce a color conversion information pattern corresponding to the example 5-5, according to which the CLUT “B” is allocated to a region defined by 0≦y≦139 and the CLUT “A” is allocated to a region defined by 140≦y≦239 with the boundary equal to y=139.

An example 5-6 is obtainable when the designated coordinate point is equal to (x, y)=(719, 139). The horizontal line passing through the coordinate point (719, 139) can provide two (upper and lower) dissected regions to which color look-up tables “C” and “D” are respectively allocated.

More specifically, the coordinate designation section 110 can control the selection signal (“selector2” shown in FIG. 1) supplied to the CLUT output selector 107 so as to produce a color conversion information pattern corresponding to the example 5-6, according to which the CLUT “D” is allocated to a region defined by 0≦y≦139 and the CLUT “C” is allocated to a region defined by 140≦y≦239 with the boundary equal to y=139.

In this manner, designating a coordinate point can define a combination of vertical and/or horizontal lines which provide dissected regions to which CLUT information can be respectively allocated.

As described above, the digital video camera according to the first exemplary embodiment can supply a main picture (video) with overlaid/mixed OSD data to an EVF, a liquid crystal display panel, or a television monitor.

The first exemplary embodiment can substantially increase the total number of colors displayable on the screen by arbitrarily switching the display regions of color conversion information contained in the OSD data on the screen.

Thus, the first exemplary embodiment can realize an increased number of colors displayed on the same screen, without increasing the information amount of OSD drawing data and without increasing the transfer amount of OSD drawing data from a memory. Since the number of displayed colors is increased, high-definition OSD data can be displayed.

### Second Exemplary Embodiment

An image display apparatus according to a second exemplary embodiment will be described with reference to attached drawings. The second exemplary embodiment is different from the first exemplary embodiment in the method for designating coordinate values defining the regions to which color look-up tables are allocated as well as in the method for switching/applying the color look-up tables.

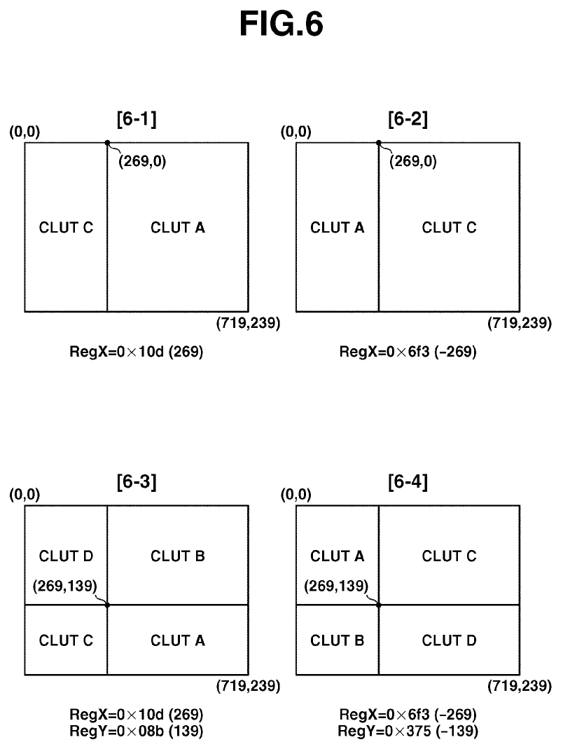

FIG. 6 illustrates plural examples with respect to allocation of color look-up tables. In each example shown in FIG. 6, the entire video range (i.e., effective video range) corresponds to a field defined by 0≦x≦719 and 0≦y≦239 in which “x” represents the horizontal direction and “y” represents the vertical direction. The coordinate designation section 110 can designate an arbitrary coordinate point within a range defined by −719≦x≦719 and −239≦y≦239.

When the designated coordinate point has positive coordinate values, the image display apparatus performs the control similar to that of the first exemplary embodiment.

However, when the designated coordinate point has negative coordinate values, the second exemplary embodiment can switch allocation of the look-up tables to the dissected regions. The coordinate designation of the second exemplary embodiment, if carried out using arbitrary register settings, can be easily realized by controlling the value set in the register as “signed” not as “unsigned” value.

The combination of vertical and/or horizontal lines passing through the designated coordinate can provide various dissected regions according to which the color look-up tables can be changed.

If the designated coordinate point has positive values, the image display apparatus can realize the designation of dissected regions and allocation of color look-up tables shown in FIG. 5, as described in the first exemplary embodiment. FIG. 6 illustrates various designation/allocation examples realized when the designated coordinate point has negative values.

In the exemplary embodiment, the register designating a coordinate point includes a register RegX designating an x-coordinate value and a register RegY designating a y-coordinate value. Furthermore, the x-coordinate has a range from −719 to +719 and can be expressed as a signed 11-bit value while the y-coordinate has a range from −239 to +239 and can be expressed as a signed 10-bit value.

According to an example 6-1, RegX is 0x10d (=269 if converted into a decimal number from the signed 11-bit value) and RegY is 0x000 (=0 if converted into a decimal number from the signed 10-bit value). Thus, the coordinate point designated by the aforementioned register is equal to (x, y)=(269, 0). The vertical line passing through the coordinate point (269, 0) can provide two (right and left) dissected regions to which color look-up tables “C” and “A” are allocated.

More specifically, the coordinate designation section 110 can control the selection signal (“selector2” shown in FIG. 1) supplied to the CLUT output selector 107 so as to produce a color conversion information pattern corresponding to the example 6-1, according to which the CLUT “C” is allocated to a region defined by 0≦x≦269 and the CLUT “A” is allocated to a region defined by 270≦x≦719 with the boundary equal to x=269. The color conversion information pattern of the example 6-1 is identical to that of the example 5-3 shown in FIG. 5.

According to an example 6-2, in the register designating a coordinate point, RegX is 0x6f3 (=−269 if converted into a decimal number from the signed 11-bit value) and RegY is 0x000 (=0 if converted into a decimal number from the signed 10-bit value). The coordinate point designated by the aforementioned register is equal to (x, y)=(−269, 0).

However, no negative values can be defined on the coordinates of the display screen. Therefore, the present exemplary embodiment converts the negative coordinate point (−269, 0) into a positive coordinate point having the same absolute value, i.e., (x, y)=(269, 0), as actual designation coordinates. Thus, similar to the example 6-1, the vertical line passing through the coordinate point (269, 0) can provide two (right and left) dissected regions. However, compared to the example 6-1, the color look-up tables “A” and “C” are allocated in a symmetrically opposed relationship to the dissected regions.

More specifically, the coordinate designation section 110 can control the selection signal (“selector2” shown in FIG. 1) supplied to the CLUT output selector 107 so as to produce a color conversion information pattern corresponding to the example 6-2, according to which the CLUT “A” is allocated to a region defined by 0≦x≦269 and the CLUT “C” is allocated to a region defined by 270≦x≦719 with the boundary equal to x=269.

According to an example 6-3, in the register designating a coordinate point, RegX is 0x10d (=269 if converted into a decimal number from the signed 11-bit value) and RegY is 0x08b (=139 if converted into a decimal number from the signed 10-bit value). The coordinate point designated by the aforementioned register is equal to (x, y)=(269, 139). The vertical and horizontal lines passing through the coordinate point (269, 139) can provide a total of four dissected regions to which color look-up tables “A” through “D” are respectively allocated.

Thus, to realize video display and OSD overlay/mix processing in the horizontal line direction, the coordinate designation section 110 can control the selection signal (“selector2” shown in FIG. 1) supplied to the CLUT output selector 107 so as to produce a color conversion information pattern corresponding to the example 6-3, according to which the CLUT “D” is allocated to a region defined by 0≦x≦269 and 0≦y≦139; the CLUT “B” is allocated to a region defined by 270≦x≦719 and 0≦y≦139; the CLUT “C” is allocated to a region defined by 0≦x≦269 and 140≦y≦239; and the CLUT “A” is allocated to a region defined by 270≦x≦719 and 140≦y≦239. The color conversion information pattern of the example 6-3 is identical to that of the example 5-2 shown in FIG. 5.

According to an example 6-4, in the register designating a coordinate point, RegX is 0x6f3 (=−269 if converted into a decimal number from the signed 11-bit value) and RegY is 0x375 (=−139 if converted into a decimal number from the signed 11-bit value). The coordinate point designated by the aforementioned register is equal to (x, y)=(−269, −139).

However, no negative values can be defined on the coordinates of the display screen. Therefore, the present exemplary embodiment converts the negative coordinate point (−269, −139) into a positive coordinate point having the same absolute value, i.e., (x, y)=(269, 139), as actual designation coordinates. Thus, similar to the example 6-3, the vertical and horizontal lines passing through the coordinate point (269, 139) can provide four dissected regions. However, compared to the example 6-3, the color look-up tables “A” through “D” are allocated in a symmetrically opposed relationship to the dissected regions in both vertical and horizontal directions.

More specifically, to realize video display and OSD overlay/mix processing in the horizontal line direction, the coordinate designation section 110 can control the selection signal (“selector2” shown in FIG. 1) supplied to the CLUT output selector 107 so as to produce a color conversion information pattern corresponding to the example 6-4, according to which the CLUT “A” is allocated to a region defined by 0≦x≦269 and 0≦y≦139; the CLUT “C” is allocated to a region defined by 270≦x≦719 and 0≦y≦139; the CLUT “B” is allocated to a region defined by 0≦x≦269 and 140≦y≦239; and the CLUT “D” is allocated to a region defined by 270≦x≦719 and 140≦y≦239.

As described above, designating one coordinate point can define a combination of vertical and/or horizontal lines that can provide a plurality of dissected regions to which color look-up tables are respectively allocated. Furthermore, the color conversion information pattern can be symmetrically switched by designating negative coordinate values.

As described above, similar to the first exemplary embodiment, the digital video camera according to the second exemplary embodiment can supply a main picture (video) with overlaid/mixed OSD data to an EVF, a liquid crystal display panel, or a television monitor.

The second exemplary embodiment can substantially increase the total number of colors displayable on the screen by arbitrarily changing the display regions of color conversion information contained in the OSD data on the screen. Thus, the second exemplary embodiment can realize an increased number of colors displayed on the same screen, without increasing the information amount of OSD data and without increasing the transfer amount of OSD drawing data from a memory.

Furthermore, allocation of the color conversion information pattern to the dissected regions can be symmetrically switched by designating negative coordinate values. Thus, various OSD control can be realize without using complicated circuit arrangements and controls.

### Third Exemplary Embodiment

An image display apparatus according to a third exemplary embodiment will be described with reference to attached drawings. The third exemplary embodiment is different from the first and second exemplary embodiments in the method for designating coordinate allocation of color look-up tables.

The above-described first and second exemplary embodiments designate only one coordinate point and can realize simplified controls. On the other hand, to realize more accurate controls and various on-screen displays, the third exemplary embodiment can designate two coordinate points on the display screen.

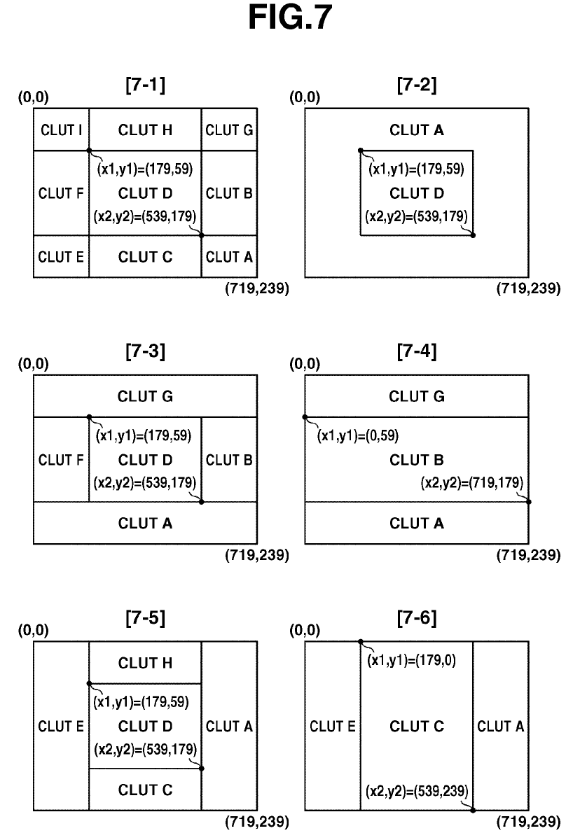

FIG. 7 illustrates plural examples with respect to allocation of color look-up tables, in which “x” represents the horizontal direction and “y” represents the vertical direction.

Similar to the first exemplary embodiment shown in FIG. 5, an effective video range corresponds to a field. According to the examples shown in FIG. 7, the effective video range is defined by 0≦x≦719 and 0≦y≦239. The coordinate designation section 110 can designate two coordinate points within the effective video range. As described above, designating two coordinate points can define two combinations of vertical and/or horizontal lines that can provide a plurality of dissected regions to which color look-up tables are respectively allocated.

An example 7-1 is obtainable when the designated coordinate points are (x1, y1)=(179, 59) and (x2, y2)=(539, 179). The vertical and horizontal lines passing through two coordinate points (179, 59) and (539, 179) can provide a total of nine dissected regions to which color look-up tables “A” through “I” are respectively allocated.

More specifically, to realize video display and OSD overlay/mix processing in the horizontal direction, the coordinate designation section 110 can control the selection signal (“selector2” shown in FIG. 1) supplied to the CLUT output selector 107 so as to produce a color conversion information pattern corresponding to the example 7-1, according to which the CLUT “I” is allocated to a region defined by 0≦x≦179 and 0≦y≦59; the CLUT “H” is allocated to a region defined by 180≦x≦539 and 0≦y≦59; the CLUT “G” is allocated to a region defined by 540≦x≦719 and 0≦y≦59; the CLUT “F” is allocated to a region defined by 0≦x≦179 and 60≦y≦179; the CLUT “D” is allocated to a region defined by 180≦x≦539 and 60≦y≦179; the CLUT “B” is allocated to a region defined by 540≦x≦719 and 60≦y≦179; the CLUT “E” is allocated to a region defined by 0≦x≦179 and 180≦y≦239; the CLUT “C” is allocated to a region defined by 180≦x≦539 and 180≦y≦239; and the CLUT “A” is allocated to a region defined by 540≦x≦719 and 180≦y≦239.

An example 7-2 is similar to the example 7-1 in that two coordinate points can be designated but different in the method for dividing the regions and allocating color look-up tables. More specifically, the example 7-2 provides two regions inside and outside a rectangle having two diagonal points equal to two designated coordinate points.

More specifically, the coordinate designation section 110 can control the selection signal (“selector2” shown in FIG. 1) supplied to the CLUT output selector 107 so as to produce a color conversion information pattern corresponding to the example 7-2, according to which the CLUT “A” is allocated to a region defined by 0≦y≦59; the CLUT “A” is allocated to a region defined by 0≦x≦179 and 60≦y≦179; the CLUT “A” is allocated to a region defined by 540≦x≦719 and 60≦y≦179; the CLUT “D” is allocated to a region defined by 180≦x≦539 and 60≦y≦179; and the CLUT “A” is allocated to a region defined by 180≦y≦239.

Examples 7-3 through 7-6 are similar to the above-described examples in that designating two coordinate points defines vertical and/or horizontal lines that can provide a plurality of dissected regions to which color look-up tables are respectively allocated.

As described above, similar to the first and second exemplary embodiments, the digital video camera according to the third exemplary embodiment can supply a main picture (video) with overlaid/mixed OSD data to an EVF, a liquid crystal display panel, or a television monitor.

The third exemplary embodiment can substantially increase the total number of colors displayable on the screen by arbitrarily switching the display regions of color conversion information contained in the OSD data on the screen. Thus, the third exemplary embodiment can realize an increased number of colors displayed on the same screen, without increasing the information amount of OSD data and without increasing the transfer amount of OSD data from a memory.

### Fourth Exemplary Embodiment

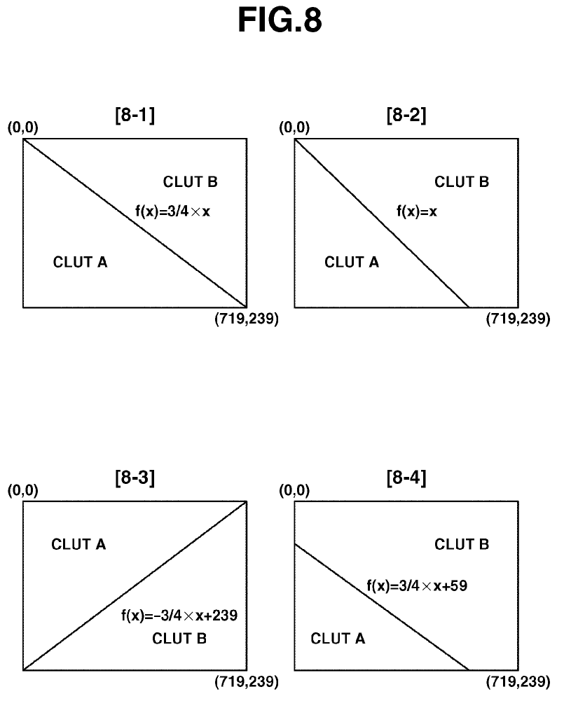

The fourth exemplary embodiment can use, instead of designating one or more specific coordinate points, an arbitrary coordinate function that can define dissected regions on the display screen. In the fourth exemplary embodiment, the coordinate designation section 110 can generate a coordinate designation function so as to realize a color conversion information pattern, for example, shown in FIG. 8.

According to an example 8-1, a straight line defined by the coordinate designation function f(x)=(¾)*x can provide two triangular regions to which the color look-up tables “A” and “B” are respectively allocated. In each example, “x” represents the horizontal coordinate of the OSD overlay/mix coordinates.

More specifically, the coordinate designation section 110 can control the selection signal (“selector2” shown in FIG. 1) supplied to the CLUT output selector 107 so as to produce a color conversion information pattern corresponding to the example 8-1, according to which the CLUT “B” is allocated to a region defined by y≦f(x) and the CLUT “A” is allocated to a region defined by y>f(x).

According to an example 8-2, a straight line defined by the function f(x)=x can provide a triangular region to which the CLUT “A” is allocated and a trapezoidal region to which the CLUT “B” is allocated.

According to example 8-3, a straight line defined by the function f(x)=−(¾)*x+239 can provide two triangular regions to which the color look-up tables “A” and “B” are respectively allocated.

According to an example 8-4, a straight line defined by the function f(x)=(¾)*x+59 can provide a triangular region to which the CLUT “A” is allocated and a pentagonal region to which the CLUT “B” is allocated.

As described above, designating two coordinate points can define two combinations of vertical and/or horizontal lines that can provide a plurality of dissected regions to which color look-up tables are respectively allocated.

Furthermore, the coordinate designation function f(x) is not limited to a straight line.

As described in the first to fourth exemplary embodiments, when a main picture (video) with overlaid/mixed OSD data is supplied to an EVF, a liquid crystal display panel, or a television monitor, the color conversion information of the OSD data can be arbitrarily switched depending on the display regions on the screen. The total number of colors displayable on the screen can be substantially increased. As a result, an increased number of colors can be displayed on the same screen, without increasing the information amount of OSD data and without increasing the transfer amount of OSD data from a memory.

In particular, if applied to a digital video camera having a video display section, the present invention can substantially increase the OSD colors displayable on the same screen without increasing the original information amount of OSD drawing data to be displayed.

Furthermore, according to the present invention, the information amount of original OSD drawing data is not increased and accordingly a required memory access band is not increased.

For example, without changing the conventional bitmap OSD drawing data and memory access format, the present invention can easily increase the number of OSD colors usable for displaying text information and various icons, including device action setting menus.

Thus, the visibility and the design of a display section can be improved. Although the present invention has been described with reference to four exemplary embodiments, the present invention is not limited to digital video cameras and can be widely applied to any other display apparatus (or devices) having the OSD function.

For example, the present invention can be applied to television receivers, digital cameras, and portable information terminals which have image display units. Furthermore, application of the present invention is not limited to the OSD and therefore includes superimposition or other composite processing.

Furthermore, software program code for realizing the functions of the above-described exemplary embodiments can be supplied to a system or an apparatus connected to various devices. A computer (or CPU or micro-processing unit (MPU)) in the system or the apparatus can execute the program to operate the devices to realize the functions of the above-described exemplary embodiments. Accordingly, the present invention encompasses the program code installable in a computer when the functions or processes of the exemplary embodiments can be realized by the computer.

In this case, the program code itself can realize the functions of the exemplary embodiments. The equivalents of programs can be used if they possess comparable functions. Furthermore, the present invention encompasses the means for supplying the program code to a computer, such as a storage (or recording) medium storing the program code.

In this case, the type of program can be any one of object code, interpreter program, and OS script data. A storage medium supplying the program can be selected from any one of a flexible (floppy) disk, a hard disk, an optical disk, a magneto-optical (MO) disk, a compact disk—ROM (CD-ROM), a CD-recordable (CD-R), a CD-rewritable (CD-RW), a magnetic tape, a nonvolatile memory card, a ROM, and a DVD (DVD-ROM, DVD-R).

The method for supplying the program includes accessing a home page on the Internet using the browsing function of a client computer, when the home page allows each user to download the computer program of the present invention, or compressed files of the programs having automatic installing functions, to a hard disk or other recording medium of the user.

Furthermore, the program code constituting the programs of the present invention can be divided into a plurality of files so that respective files are downloadable from different home pages. Namely, the present invention encompasses WWW servers that allow numerous users to download the program files so that the functions or processes of the present invention can be realized on their computers.

Furthermore, enciphering the programs of the present invention and storing the enciphered programs on a CD-ROM or comparable recording medium is an exemplary method when the programs of the present invention are distributed to the users. The authorized users (i.e., users satisfying predetermined conditions) are allowed to download key information from a page on the Internet. The users can decipher the programs with the obtained key information and can install the programs on their computers. When the computer reads and executes the installed programs, the functions of the above-described exemplary embodiments can be realized.

Furthermore, an operating system (OS) or other application software running on the computer can execute part or all of the actual processing based on instructions of the programs.

Furthermore, the program code read out of a storage medium can be written into a memory of a function expansion board equipped in a computer or into a memory of a function expansion unit connected to the computer. In this case, based on an instruction of the program, a CPU provided on the function expansion board or the function expansion unit can execute part or all of the processing so that the functions of the above-described exemplary embodiments can be realized.

The present invention can be applied to a system including plural devices or can be applied to a single apparatus. Moreover, the present invention can be realized by supplying the program(s) to a system or an apparatus. In this case, the system or the apparatus can read the software program relating to the present invention from a storage medium.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-000669 filed Jan. 5, 2006, which is hereby incorporated by reference herein in its entirety.

What is claimed is:

1. An apparatus configured to combine drawing data with image data and display a composite image, the apparatus comprising:
an image input unit configured to input image data;
a drawing data input unit configured to input drawing data;
a color conversion information holding unit configured to hold color conversion information for performing a color conversion of pixels of the drawing data;
a composite processing unit configured to combine the image data inputted by the image input unit with drawing data converted based on the color conversion information; and
a change unit configured to change the color conversion information allocated to the drawing data within a same display screen.

2. The apparatus according to claim 1, wherein the color conversion information holding unit holds a plurality of color conversion information patterns, and the change unit changes the color conversion information allocated to the drawing data by selecting one of the plurality of color conversion information patterns.

3. The apparatus according to claim 1, wherein the change unit arbitrarily switches the color conversion information pattern within the same display screen depending on display regions of the drawing data.

4. The apparatus according to claim 1, further comprising a coordinate designation unit configured to designate arbitrary coordinates on the display screen, wherein the change unit changes the color conversion information allocated to the drawing data within the same display screen based on the coordinates designated by the coordinate designation unit.

5. The apparatus according to claim 4, further comprising a control unit configured to realize a color conversion information pattern including one, or two, or four regions to which color conversion information are independently allocated, when one coordinate point is designated by the coordinate designation unit.

6. The apparatus according to claim 5, wherein the coordinate designation unit can designate an integer as well as a natural number as a coordinate value of the display screen, and when a negative coordinate value is designated by the coordinate designation unit, the change unit switches the color conversion information pattern to a pattern applied when the selected coordinate is a positive and same absolute value.

7. The apparatus according to claim 1, wherein the change unit divides the display screen into dissected regions using an arbitrary function so that the color conversion information can be changed for each dissected region.

8. The apparatus according to claim 1, wherein the drawing data is on-screen display data.

9. A method for combining drawing data with image data and displaying a composite image, the method comprising:
receiving image data;
receiving drawing data;
combining the image data with drawing data converted based on color conversion information for performing a color conversion of pixels of the drawing data; and
changing the color conversion information allocated to the drawing data within a same display screen.

10. A computer-readable medium storing instructions which, when executed by an apparatus, causes the apparatus to perform operations comprising:
receiving image data;
receiving drawing data;
combining the image data with drawing data converted based on color conversion information for performing a color conversion of pixels of the drawing data; and
changing the color conversion information allocated to the drawing data within a same display screen.

11. An imaging apparatus including an image display apparatus configured to combine drawing data with image data and display a composite image, the image display apparatus comprising:
an image input unit configured to input image data;
a drawing data input unit configured to input arbitrary drawing data;
a color conversion information holding unit configured to hold color conversion information for performing a color conversion of pixels of the drawing data;
a composite processing unit configured to combine the image data inputted by the image input unit with drawing data converted based on the color conversion information; and
a change unit configured to change the color conversion information allocated to the drawing data within a same display screen.
